(19) United States
(12) Patent Application Publication
(10) Pub. No.: US 2016/0180730 A1
(43) Pub. Date: Jun. 23, 2016

(54) METHOD FOR AUTOMATICALLY GENERATING BLANK FILLING QUESTION AND RECORDING MEDIUM DEVICE FOR RECORDING PROGRAM FOR EXECUTING SAME

(71) Applicant: POSTECH ACADEMY-INDUSTRY FOUNDATION, Pohang-si, Gyeongsangbuk-do (KR)

(72) Inventors: Geun Bae LEE, Pohang-si, Gyeongsangbuk-do (KR); Kyu Song LEE, Seoul (KR)

(21) Appl. No.: 14/909,270

(22) PCT Filed: May 7, 2014
(86) PCT No.: PCT/KR2014/004013

§ 371 Date: Feb. 1, 2016

(30) Foreign Application Priority Data
Aug. 5, 2013 (KR) 10-2013-0092411

(51) Int. Cl. G09B 7/02; G09B 19/06

(52) U.S. Cl. CPC G09B 7/02; G09B 19/06

(57) ABSTRACT

A method for automatically generating a blank filling question comprises the steps of: selecting correct vocabulary words according to preset criteria from an input sentence; acquiring a plurality of first vocabulary words from a vocabulary word database such that a relationship between the selected correct vocabulary words and each vocabulary word in the vocabulary word database satisfies a preset first criterion; acquiring a plurality of first vocabulary words from among the plurality of first vocabulary words such that a relationship between the input sentence and each of the plurality of first vocabulary words satisfies a preset second criterion; and acquiring one or more viewing vocabulary words satisfying a preset third criterion from among the plurality of second vocabulary words by using a relationship between the plurality of second vocabulary words and the input sentence and a relationship between the plurality of second vocabulary words and the correct vocabulary words. Therefore, a blank filling question can be effectively generated.

### TECHNICAL FIELD

The present invention relates to a language processing technology, and more particularly to a method for automatically generating a blank filling question and a recording medium on which a program for executing the same is recorded.

### BACKGROUND ART

A cloze test is a test in which a correct vocabulary word for a given sentence is selected, viewing vocabulary words having similar meaning as the selected correct vocabulary word are generated, and a sentence having a blank in a position for the correct vocabulary word is provided to a user together with the selected correct vocabulary word and the viewing vocabulary words. The cloze test is used for foreign language education or for evaluating foreign language abilities.

The cloze test was originated from a Gestalt theory, which is a theory based on that a human has an unconscious psychology of filling a broken part or a blank space of an object when the human observes a shape of the object. Also, according to the theory, as a human is more familiar with an object, the human can identify the object more easily. The Gestalt theory was applied to language education whereby the theory has been developed to a learning theory that better linguistic ability gives better blank filling ability. Also, the cloze test has been introduced based on the theory.

The first cloze test was developed by Taylor in 1952 for use of evaluating difficulty in reading, and widely distributed by John Oiler in 1971. Until now, it has been widely used for foreign language ability testing or education of foreign languages.

However, traditional methods for generating blank filling questions simply enumerate the predetermined number of viewing vocabulary words having similar meaning as a correct vocabulary word from a vocabulary word database. Since the viewing vocabulary words generated in such the manner may be too evidently incorrect vocabulary words as compared to the correct vocabulary word, they may be not suitable for the foreign language ability testing or foreign language education. Thus, there is inconvenience that additional processing on the generated blank filling question should be required.

### DISCLOSURE

### Technical Problem

The purpose of the present invention for resolving the above-described problems is to provide a method for automatically generating blank filling questions which can improve effectiveness of foreign language ability testing and foreign language education.

Also, another purpose of the present invention is to provide a recording medium on which a program code for executing the method of automatically generating blank filling questions is recorded.

### Technical Solution

In some example embodiments of the present invention, a method for automatically generating a blank filling question, performed in a digital information processing apparatus, may comprise selecting a correct word according to preset criteria from an input sentence; acquiring a plurality of first words from a vocabulary database such that a relationship between the selected correct word and each of the plurality of first words satisfies a preset first criterion; acquiring a plurality of second words from the plurality of first words such that a relationship between the input sentence and each of the plurality of second words satisfies a preset second criterion; and acquiring one or more viewing words satisfying a preset third criterion from the plurality of second words by using a relationship between each of the plurality of second words and the input sentence and a relationship between each of the plurality of second words and the correct word.

Here, the acquiring a plurality of first words may comprise calculating at least one similarity for each word of the vocabulary database by comparing the correct word and each word of the vocabulary database; calculating first similarities for each word of the vocabulary database by using one or more of the at least one similarity; and acquiring a plurality of words whose first similarities satisfy a preset criterion from the vocabulary database as the plurality of first words.

Here, in the calculating at least one similarity, each word in the vocabulary database may be compared with the correct word so that semantic similarity, phonetic similarity, and spelling similarity for the each word are calculated.

Here, the acquiring a plurality of second words from the plurality of first words may comprise calculating a similarity of each word of the plurality of first words to the input sentence as a second similarity of each word of the plurality of first words by comparing each of the plurality of first words with the input sentence; and comparing the second similarity of each of the plurality of first words with a predetermined threshold, and acquiring a plurality of words whose second similarities satisfy a predetermined threshold as the plurality of second words from the plurality of first vocabulary words.

Here, the second similarity may be calculated by applying first weighting values for adjusting selection of the plurality of second words to the similarity between the input sentence and each of the plurality of first words.

Here, the acquiring one or more viewing words may comprise generating a distributed semantic matrix satisfying a first predetermined criterion based on at least one vocabulary database and at least one text database; generating a S row vector which has a same column size and same column indexes as the distributed semantic matrix and satisfies a second predetermined criterion for words except the correct word in the input sentence; calculating input sentence similarities of the respective plurality of second words by using the S row vector, calculating correct word similarities of the respective plurality of second words by using the distributed semantic matrix; calculating third similarities of the respective plurality of second words based on the input sentence similarities of the respective plurality of second words and the correct word similarities of the respective plurality of second words; and acquiring, as the one or more view words, words whose third similarities satisfy a third predetermined criterion from the plurality of second words.

Here, in the calculating input sentence similarities of the respective plurality of second words, row vectors of the distributed semantic matrix corresponding to the respective plurality of second words and the S row vector are used to calculate the input sentence similarities of the respective plurality of second words.

Here, in the calculating correct word similarities of the respective plurality of second words, row vectors of the distributed semantic matrix corresponding to the respective plurality of second words and a row vector of the distributed semantic matrix corresponding to the correct word are used to calculate the correct word similarities of the respective plurality of second words.

Here, in the calculating third similarities of the respective plurality of second words, the third similarities are calculated by respectively applying second weighting values for adjusting influences that each of the input sentence similarities and the correct word similarities cause on the third similarities to the input sentence similarities and the correct word similarities.

In other example embodiments of the present invention, a computer-readable recording medium on which a program which can be read out by a digital processing apparatus and in which a method for automatically generating a blank filling question is implemented is recorded may be provided. Also, the program may execute a step of selecting a correct word according to preset criteria from an input sentence; a step of acquiring a plurality of first words from a vocabulary database such that a relationship between the selected correct word and each of the plurality of first words satisfies a preset first criterion; a step of acquiring a plurality of second words from the plurality of first words such that a relationship between the input sentence and each of the plurality of second words satisfies a preset second criterion; and a step of acquiring one or more viewing words satisfying a preset third criterion from the plurality of second words by using a relationship between each of the plurality of second words and the input sentence and a relationship between each of the plurality of second words and the correct word.

### Advantageous Effects

According to the above-described method for automatically generating a blank filling question and a recording medium storing the program for executing the method, a correct word is compared to each word in a vocabulary database, and semantic similarities, phonetic similarities, and spelling similarities of respective words in the vocabulary database to the correct word are calculated. Then, at least one of the calculated similarities is used for extracting a plurality of first words among the words in the vocabulary database. Then, second similarities of the plurality of first words which are similarities of the respective first words to the input sentence and calculated as probability values are compared with a threshold, and a plurality of second words are acquired from the plurality of first words. Also, a distributed semantic matrix and a S row vector are generated based on one or more vocabulary databases and one or more text databases. Then, based on the generated distributed semantic matrix and the generated S row vector, input sentence similarities of the respective second words to the input sentence and correct word similarities of the respective second words to the correct word are calculated. Then, based on the input sentence similarities and the correct word similarities, third similarities of the respective second words are calculated and used to acquire one or more viewing words from the plurality of second words.

Therefore, candidate viewing words having lower relevance to the correct word are filtered such that a blank filling question can be efficiently generated. Through this, necessity of regenerating the blank filling question can be reduced.

Also, relations between viewing words and the correct word are not restricted to the semantic similarities, the phonetic similarities, and the spelling similarities. All properties which the correct word can have, such as antonyms, standard languages, examples, refined words, and examples, can be applied to the filtering of the viewing words.

Also, without being restricted to a specific language, if vocabulary databases and text databases whose target languages are same as a language of an input sentence are prepared, blank filling questions for various languages can be generated.

### DESCRIPTION OF DRAWINGS

FIG. 1 is a flow chart illustrating a method for automatically generating a blank filling question according to an exemplary embodiment of the present invention.

FIG. 2 is a flow chart for explaining a procedure of acquiring a plurality of first words illustrated in FIG. 1 in detail.

FIG. 3 is a flow chart illustrating a procedure of acquiring a plurality of second words of FIG. 1 specifically.

FIG. 4 is a flow chart illustrating the procedure of acquiring one or more viewing words of FIG. 1 in detail.

### BEST MODE

The present invention may be variously modified and may include various embodiments. However, particular embodiments are exemplarily illustrated in the drawings and will be described in detail.

However, it should be understood that the particular embodiments are not intended to limit the present disclosure to specific forms, but rather the present disclosure is meant to cover all modification, similarities, and alternatives which are included in the spirit and scope of the present disclosure. Like reference numerals refer to like elements throughout the description of the drawings.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments according to the present disclosure will be explained in detail. For easiness of understanding, same reference numbers will be used for same components in accompanying drawings, and redundant explanation of same components will be omitted.

Also, a method for automatically generating a blank filling question according to an exemplary embodiment of the present disclosure, which will be described hereinafter, may be implemented as a software program, and an information processing apparatus capable of processing digital signals may read the software program and execute the same. Here, the information processing apparatus may be at least one of various apparatuses such as a computer, a laptop computer, a smartphone, a pad-type terminal, etc. Hereinafter, for convenience of explanation, the information processing apparatus may be referred to as ‘computer’. However, the method according to the present disclosure may be executed by not only a computer but also one of various apparatuses having capability of digital signal processing. Also, a method for automatically generating a blank filling question according to an exemplary embodiment of the present disclosure may be implemented as one or more hardware chips.

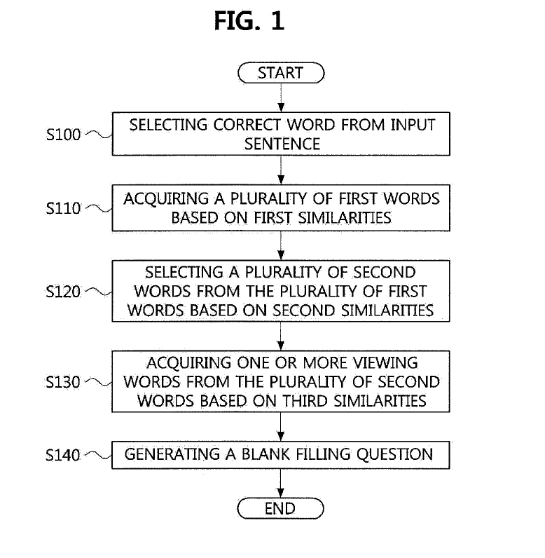

FIG. 1 is a flow chart illustrating a method for automatically generating a blank filling question according to an exemplary embodiment of the present invention. FIG. 1 briefly illustrates a complete procedure of the method for automatically generating a blank filling question.

Hereinafter, the method according to an exemplary embodiment of the present invention will be explained.

Referring to FIG. 1, a computer may select at least one correct word from an input sentence according to preset criteria (S100). For example, if a sentence “According to the information board at the city bus terminal, buses bound for Orchard Road, and Bridgeway Park are scheduled to depart every hour” is given, a word “scheduled” may be selected as the correct word based on the preset criteria. According to exemplary embodiments, the input sentence may be inputted in various manners. For example, the input sentence may be selected from a text database or from a plurality of sentences stored in the computer. Also, the input sentence may be inputted by using a user interface through a wireless network or a wire network. However, the input method of the input sentence may not be restricted to the above-described methods, and any known methods can be used for inputting the input sentence. Also, the preset criteria may be predetermined conditions. For example, at least one of a conditional random field (CRF) manner, a linear-chain CRFs manner, a general CRFs manner, a hidden-state CRFs manner, a first-order and second-order Markov CRFs manner, a first restricted linear-chain CRFs manner, and any other predetermined manner may be used as the predetermined conditions.

Alternatively, a user interface such as a menu screen may be provided for setting the preset criteria, and a user may configure the preset criteria by using the user interface.

However, the conditions used for selecting the correct word from the input sentence may not be restricted to the above-described manners.

For example, without using the preset criteria, a user interface for the user to directly select the correct word from the input sentence may be provided to the user, and the user may directly select the correct word.

Re-referring to FIG. 1, after the correct word is selected from the input sentence in the step S100 as described above, the computer may acquire a plurality of first words according to first similarities based on a preset criterion (S110). Here, the selected correct word may be compared with respective words included in a vocabulary database to calculate first similarities between respective words and the correct word. Then, the plurality of first words may be acquired from words in the vocabulary database whose first similarities satisfy the preset criterion. For example, the computer may compare the correct word “scheduled” selected from the input sentence with respective words in the vocabulary database, and acquire words having higher first similarities (e.g., {fare, plan, program, docket, time, book} in the vocabulary database) as the plurality of first words.

Also, the computer may further perform a step of converting word classes of the acquired plurality of first words into a word class of the correct word. For example, the computer may convert the acquired words {fare, plan, program, docket, time, book} to {fared, planned, programmed, docketed, timed, booked} such that the converted words have the same word classes as that of the correct word “scheduled”.

Then, the computer may acquire a plurality of second words from the plurality of first words according to second similarities of the plurality of first words (S120). Here, the computer may calculate similarities of the respective first words as probability values of the respective first words, assign the calculated probability values as the second similarities of the respective first words, and acquire a plurality of second words based on results of comparison between the second similarities and a preset criterion. For example, the computer may remove (programmed, timed) whose second similarities do not satisfy the preset criterion from the plurality of first words (fared, planned, programmed, docketed, timed, booked), and acquire the remaining words (fared, planned, docketed, booked) as the plurality of second words.

Then, the computer may acquire one or more viewing words from the plurality of second words according to third similarities of the respective second words (S130). Here, the computer may calculate third similarities of the respective second words based on similarities between the input sentence and the respective second words and similarities between the correct word and the respective second words, and acquire the one or more viewing words from the plurality of second words based on third similarities of the plurality of second words. For example, the computer may acquire one or more viewing words {fared, planned, booked} from the plurality of second words {fared, planned, docketed, booked} based on third similarities of the plurality of second words.

Then, the computer may generate a blank filling question with the acquired viewing words, the correct word, and a question sentence having a blank in a position of the correct word (S140). For example, the computer may construct a blank filling question by generating the question sentence ‘According to the information board at the city bus terminal, buses bound for Orchard Road, and Bridgeway Park are to depart every hour.’ from the input sentence, and providing “a) fared b) planned c) booked d) scheduled” as the viewing words and the correct word.

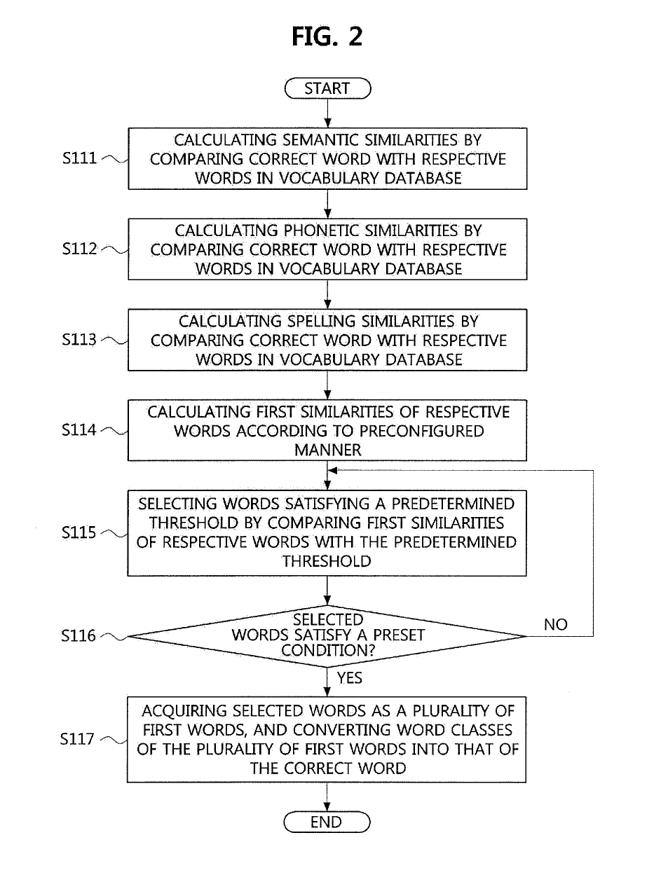

FIG. 2 is a flow chart for explaining a procedure of acquiring a plurality of first words illustrated in FIG. 1 in detail. That is, FIG. 2 specifically illustrates the step of acquiring the plurality of first words from a vocabulary database.

Hereinafter, the step of acquiring the plurality of first words will be explained more specifically by referring to FIG. 2.

Referring to FIG. 2, the computer may compare the selected correct word with respective words in the vocabulary database, thereby calculating semantic similarities of respective words in the vocabulary database, which mean similarities between meaning of the correct word and meanings of respective words in the vocabulary database (S111).

Also, the computer may compare the selected correct word with respective words in the vocabulary database, thereby calculating phonetic similarities of respective words in the vocabulary database, which mean similarities between pronunciation of the correct word and pronunciations of respective words in the vocabulary database (S112).

Also, the computer may compare the selected correct word with respective words in the vocabulary database, thereby calculating spelling similarities of respective words in the vocabulary database, which mean similarities between spelling of the correct word and spelling of respective words in the vocabulary database (S113).

Although it is explained that the computer sequentially performs the step of calculating semantic similarity (S11), the step of calculating phonetic similarity (S112), and the step of calculating spelling similarity (S113) in FIG. 2, it is only for convenience of explanation. That is, the above steps may be performed without being restricted to the above sequence. For example, the steps S111, S112, and S113 may be performed simultaneously, or may be performed with their sequences being altered.

Meanwhile, the semantic similarity of each of words in the vocabulary database may be calculated by using a below equation 1, the phonetic similarity of each of words in the vocabulary database may be calculated by using a below equation 2, and the spelling similarity of each of words in the vocabulary database may be calculated by using a below equation 3.

$$\begin{matrix}Semantic Similarity = {Argmax}_{{X}_{1} \to {X}_{n}} SemanticSimilarity \\ ( answerWord , X ) & [ Equation 1 ] \\ Phonetic Similarity = {Argmax}_{{X}_{1} \to {X}_{n}} Phonetic Similarity \\ ( answerWord , X ) & [ Equation 2 ] \\ Spelling Similarity = {Argmax}_{{X}_{1} \to {X}_{n}} ErrorPairCount \\ ( answerWord , X ) & [ Equation 3 ]\end{matrix}$$

In the equations 1, 2, and 3, ‘answerWord’ means the selected correct word, ‘X’ means respective words in the vocabulary database, and ‘X₁→Xₙ’ may mean that the words in the vocabulary database are sequentially inputted to the equations 1 to 3.

Here, the computer may input respective words in the vocabulary database to the equations 1 to 3, and compare the correct word with each of words in the vocabulary database thereby calculating similarities between the correct word and the respective words in the vocabulary database. That is, the computer may calculate semantic similarities of respective words in the vocabulary database by using the equation 1, calculate phonetic similarities of respective words in the vocabulary database by using the equation 2, and calculate spelling similarities of respective words in the vocabulary database by using the equation 3.

Re-referring to FIG. 2, after the semantic similarities, the phonetic similarities, and the spelling similarities are calculated as described above, the computer may calculate first similarities of respective words in the vocabulary database according to a preconfigured manner (S114). Here, the preconfigured manner for calculating the first similarities may be a manner according to the number of similarities among the semantic similarity, the phonetic similarity, and the spelling similarity which are used for calculating the first similarities. For example, the computer may calculate the first similarity of each word in the vocabulary database by using one of the semantic similarity, the phonetic similarity, and the spelling similarity, or calculate the first similarity of each word in the vocabulary database by using two of the semantic similarity, the phonetic similarity, and the spelling similarity (e.g., {semantic similarity, phonetic similarity}, {semantic similarity, spelling similarity}, or {phonetic similarity, spelling similarity}). Alternatively, the computer may calculate the first similarity of each word in the vocabulary database by using all of the semantic similarity, the phonetic similarity, and the spelling similarity.

Also, in another exemplary embodiment, the first similarity may be calculated by summing at least two of the semantic similarity, the phonetic similarity, and the spelling similarity. However, the method for calculating the first similarity is not restricted to the above method of summing. That is, the first similarity may be calculated by using various operations on the semantic similarity, the phonetic similarity, and the spelling similarity (e.g., subtraction, multiplication, division, etc.)

Also, the preconfigured manner for calculating the first similarities may be configured as fixed, or may be directly configured by a user through a user interface provided by the computer.

Re-referring to FIG. 2, the computer may select a plurality of words from the vocabulary database which satisfy a predetermined threshold by comparing the first similarities calculated for respective words in the vocabulary database with the predetermined threshold (S115). For example, the computer may select words having first similarities higher than the predetermined threshold from the vocabulary database, or may select words having first similarities lower than the predetermined threshold from the vocabulary database.

In the step S115, the predetermined threshold used for the computer to select the plurality of words may be configured as a fixed value, or may be configured by a user through a user interface.

The computer may determine whether the selected words satisfy a preset condition (S116). If the preset condition is not satisfied, the step S115 is repeated. For example, in a case that the preset condition is the number of words selected from the vocabulary database, the computer may determine whether the number of the selected words satisfies the preset condition (i.e., the predetermined number) in the step S116, and then if the preset condition is not satisfied, the step S115 may be repeated until the preset condition is satisfied. For example, if the preset condition indicates 10 to 20 words, the computer may perform the step S115 repeatedly until the number of selected words belongs to the range of 10 to 20 words.

Here, the preset condition may be configured as fixed, or may be directly configured by a user through a user interface provided by the computer.

If the selected words in the step S116 satisfy the preset condition, the computer may acquire the selected words as the plurality of first words, and convert word classes of the plurality of first words such that the word classes of the plurality of first words become identical to that of the correct word (S117).

In the procedure of acquiring the plurality of first words illustrated in FIG. 2, meaning, pronunciation, and spelling of the correct word are compared with those of respective words in the vocabulary database, and the plurality of first words are acquired based on the result of the comparisons. However, exemplary embodiments according to the present invention are not restricted to the exemplary embodiment illustrated in FIG. 2. That is, in order to acquire the plurality of first words, a relation with respect to any properties such as antonyms, standard languages, examples, dialect which words can have may be used.

Also, in yet another exemplary embodiment, words whose first similarities have the smallest values (i.e., words having converse relations with the correct word) may be acquired as some of the plurality of first words, and the blank filling question may be generated.

Also, as the vocabulary database which can be used in the exemplary embodiments, “The CMU pronouncing Dictionary of American English”, “WordNet”, “MRC Psycholinguistic Database”, “Dante”, “British National Corpus”, “Celex”, “The Verb Semantics Ontology Project” or “Twitter Current English Lexicon” may be used. However, without being restricted to the above databases, various vocabulary databases may be used. Also, without being restricted to a specific language (such as English), blank filling questions can be generated for any kind of languages if an input sentence and a vocabulary database suitable for a language used in the input sentence are given.

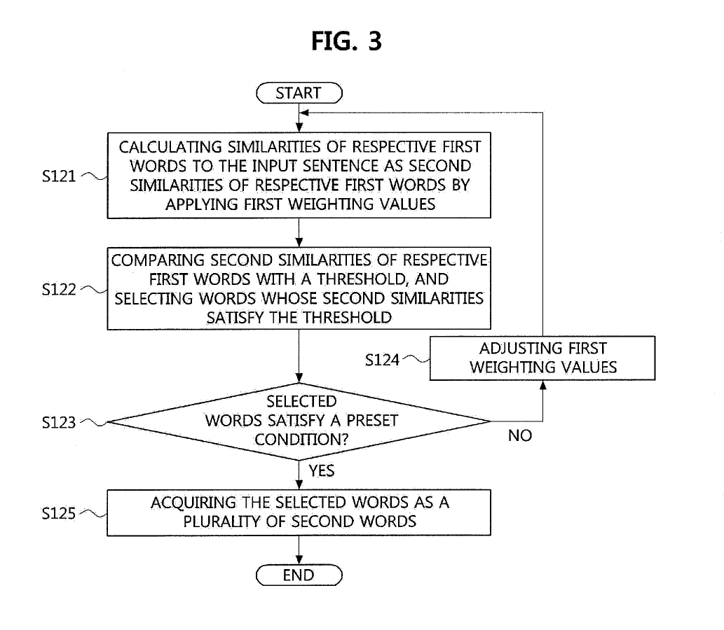

FIG. 3 is a flow chart illustrating a procedure of acquiring a plurality of second words of FIG. 1 specifically. That is, FIG. 3 illustrates a step of acquiring the plurality of second words from the plurality of first words in further detail.

Hereinafter, the procedure of acquiring the plurality of second words from the plurality of first words will be explained in detail by referring to FIG. 3.

Referring to FIG. 3, the computer may calculate similarities between the input sentence and respective first words as probability values of the respective first words by using first weighting values, and assign the calculated respective probability values as second similarities of the respective first words (S121). Here, the second similarities of the respective first words to the input sentence may be calculated as a below equation 4.

$$Second Similarity = \hat{P} ( {W}_{i} \vert {W}_{i - N}^{i - 1} {W}_{i + 1}^{i + N} ) = {\sum }_{k = 1}^{N} {\sum }_{j = 1}^{k} {λ}_{k} \frac{c ( {W}_{i - j + 1}^{i + k - j} )}{c ( {W}_{i - j + 1}^{i + k - j - 1} )} \qquad [ Equation 4 ]$$

In the equation 4, W may mean the respective first words, i may mean respective positions of W in the input sentence in reference to a position of the correct word defined as 0, N may mean N of N-gram, k may mean a variable indicating one of 1 to N, and j may mean a variable indicating one of 1 to k. The first term of the equation 4, \hat{P}(Wᵢ|W_{i-N}ⁱ⁻¹Wᵢ₊₁^{i+N}) may mean probability values of the plurality of first words W in the input sentence. For example, the first term of the equation 4 for deriving an average value of the plurality of first words i and N of which are respectively 0 and 5 may be represented as \hat{P}(W₀|W₋₄⁻⁴W₁⁴). Here, W₋₄⁻¹ means probability values for words corresponding to the first to fourth positions in the left side of the correct word with respect to the plurality of first words W, and W₁⁴ means probability values for words corresponding to the first to fourth positions in the right side of the correct word with respect to the plurality of first words W.

The probability values for the respective first words may be calculated as the second term

$${\sum }_{k = 1}^{N} {\sum }_{j = 1}^{k} {λ}_{k} \frac{c ( {W}_{i - j + 1}^{i + k - j} )}{c ( {W}_{i - j + 1}^{i + k - j - 1} )}$$

of the equation 4. Here, λ mean the first weighting values, and C(•) means a N-gram count. Here, fixed values preconfigured by the computer or values inputted by a user through a user interface may be used as the first weighting values. The second term

$$\frac{c ( {W}_{i - j + 1}^{i + k - j} )}{c ( {W}_{i - j + 1}^{i + k - j - 1} )}$$

of the equation 4 may mean a ratio of a (N−1) gram count to the N-gram count for each of the plurality of first words. That is, if N of the N-gram counter is 4,

$$\frac{c ( {W}_{i - j + 1}^{i + k - j} )}{c ( {W}_{i - j + 1}^{i + k - j - 1} )}$$

of the plurality of first vocabulary words may be (4-gram count)/(3-gram count). For example, if an input sentence “According to the information board at the city bus terminal, buses bound for Orchard Road, and Bridgeway park are [correct word] to depart every hour.” is given, N of a desired N-gram is 4, and the plurality of words is ‘fared’, the computer may generate {(Bridgeway Park are fared), (Park are fared to), (are fared to depart), (fared to depart every)} as 4-grams for ‘fared’, and generate {(Park are fared), (are fared to), (fared to depart)} as 3-grams for ‘fared’. Also, the computer may calculate (count of (Bridgeway Park are fared))/(count of (Bridgeway Park are)) as the second term of the equation 4.

Re-referring to FIG. 3, the computer may compare second similarities of the respective first words with a threshold according to a preset criterion, and select a plurality of second words whose second similarities satisfy the threshold according to a preset criterion among the plurality of first words (S122). For example, the computer may select a plurality of words having higher second similarities than the threshold or a plurality of words having lower second similarities than the threshold among the plurality of first words. Here, the threshold may be preconfigured by the computer, or inputted directly by the user through the user interface.

Re-referring to FIG. 3, the computer may determine whether the plurality of first words satisfy the preset criterion (S123). If the preset criterion is not satisfied, the first weighting values are adjusted (S124), and the steps S121 to S123 are repeated. For example, if the preset criterion is the number of words selected from the plurality of first words and the preset criterion is not satisfied in the step S123, the first weighting values are adjusted in the step S124, and the steps S121 to S123 are performed again. If the preset criterion is satisfied in the step S123, a step S125 is performed. Here, fixed values preconfigured by the computer or values inputted by the user through the user interface may be used as the first weighting values.

Re-referring to FIG. 3, the computer may acquire the words selected from the plurality of first words in the step S123 as a plurality of second words (S124).

In an exemplary embodiment according to the present disclosure, similarities of the respective first words are calculated as probability values of the equation 4, and the plurality of second words are acquired. However, exemplary embodiments according to the present disclosure are restricted to the above example. That is, any methods for defining the similarities of the respective first words for the input sentence may be used for acquiring the plurality of second words from the plurality of first words.

Also, in an exemplary embodiment according to the present disclosure, English corpuses such as ‘Google Books corpora’, ‘The Corpus of Contemporary American English’, ‘American English corpora’, ‘Michigan Corpus of Academic Spoken English’, ‘Penn and Penn-Helsinki corpora of historical and modern English’, ‘The Salamanca Corpus-Digital Archive of English Dialect Texts’, etc. or any directly composed corpus may be used as a corpus used for deriving the N-gram counter. However, exemplary embodiments are not restricted to the above examples, and any kind of corpuses which can be used for deriving corpus counter values may be used. Also, in an exemplary embodiment according to the present disclosure, the N-gram count may be calculated by using a corpus N-gram count program such as ‘Google N-gram count’, ‘Microsoft's web n-grams service’, ‘Stochastic Language Models (N-gram) Specification’, ‘Corpus of Contemporary American English n-gram’, ‘Peachnote's music n-gram’, etc. or a directly composed N-gram count program. However, exemplary embodiments are not restricted to the above examples, and any kind of corpus count programs may be used.

Also, in an exemplary embodiment according to the present disclosure, the plurality of second words may be acquired from the plurality of first words based on the second similarities of the respective first words to the input sentence so that the blank filling questions can be generated efficiently.

Also, if a corpus and a corpus count program corresponding to a language of the input sentence, the blank filling questions can by generated without being restricted to a specific language.

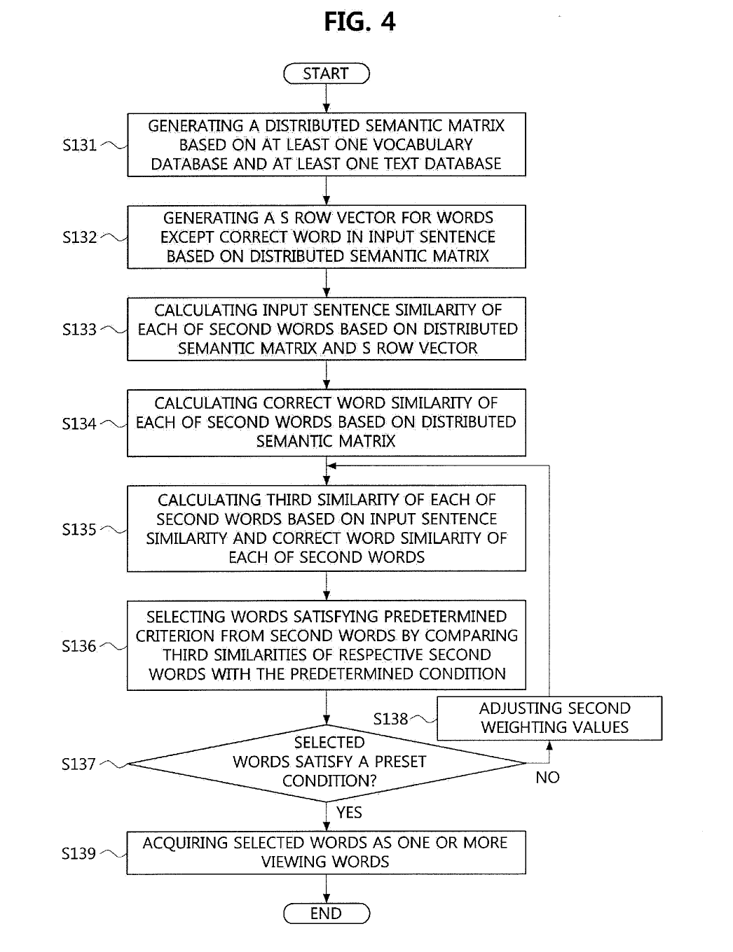

FIG. 4 is a flow chart illustrating the procedure of acquiring one or more viewing words of FIG. 1 in detail. In FIG. 4, the procedure of acquiring one or more viewing words from the plurality of second words will be explained in detail.

Hereinafter, the procedure of acquiring one or more viewing words from the plurality of second words will be explained specifically by referring to FIG. 4.

Referring to FIG. 4, the computer may generate a distributed semantic matrix for words according to a preset criterion by using one or more vocabulary databases and one or more text databases (S131). Here, the computer may select N words from the one or more vocabulary databases according to the preset criterion, and arrange the selected N words as corresponding to indexes of rows and columns of the distributed semantic matrix. For example, in the distributed semantic matrix having a size of N×N, an index of a n-th row of the matrix and an index of a n-th column of the matrix have a same word.

Here, in order to generate values of the distributed semantic matrix, a zero matrix having the size of N×N is generated as the distributed semantic matrix, and the values of elements of the matrix are generated by repeating a first repetition step, a second repetition step, and a third repetition step which will be explained later.

In the first repletion step, a text database may be selected from one or more text databases according to a preset criterion, a first sentence may be selected from the selected text database, a row and column of the distributed semantic matrix corresponding to a first word of the first sentence may be searched, and a value 1 is added to columns corresponding to a window size configured based on a predetermined condition in the corresponding row. After the above procedure for the first word of the first sentence is completed, the above step is repeated until the last word of the first sentence. For example, if the row corresponding to the first word of the first sentence is a n-th row, the corresponding column for the word also becomes a n-th column. Also, if the predetermined window size is 3, a value 1 is respectively added to a (n−3)-th column, a (n−2)-th column, a (n−1)-th column, a (n+1)-th column, a (n+2)-th column, and a (n+3)-th column of the n-th row. A fixed value or a value inputted by the user through the user interface may be used as the predetermined window size.

After the completion of the first repetition step, the computer may perform the second repetition step by repeating the first repetition steps until a last sentence of the selected text database.

After the completion of the second repletion step, the computer may perform the third repetition step by selecting a next text database according to a preset criterion and by sequentially repeating the first repetition steps and the second repetition steps. In the exemplary embodiment of FIG. 4, the computer may generate the distributed semantic matrix by preforming the first repetition steps, the second repetition steps, and the third repetition steps for the words of one or more vocabulary databases and one or more text databases, and the distributed semantic matrix may represent a distribution of neighbor words for respective words. However, without being restricted to the above-described repetition steps, any methods for representing the distribution of neighbor words for respective words may be used for exemplary embodiments of the present disclosure.

Here, the computer may generate a S row vector, having the same column size and the same column indexes as the distributed semantic matrix, for all words except the correct word in the input sentence (S132). For example, all words except the correct word in the input sentence may be searched in the corresponding column indexes of the S row vector, and a value 1 is added to the corresponding columns and a value 0 is added to a column index having no corresponding word. For example, if an input sentence “According to the information board at the city bus terminal, buses bound for Orchard Road and Bridgeway Pare are [correct word] to depart every hour.” is given, and first column indexes of the distributed semantic matrix is generated as [according, at, the, in, and, but, ok, to, any, or, therefore, . . . ], the first column indexes of the S row vector may be also generated as [according, at, the, in, and, but, ok, to, any, or, therefore, . . . ], and the corresponding S-row vector may become [1, 1, 2, 0, 1, 0, 0, 2, 0, 0, 0, . . . ]. Although an exemplary method for generating the S-row vector is explained in the exemplary embodiment of FIG. 4, exemplary embodiments according to the present disclosure are not restricted to the above exemplary method, any methods for generating the S-row vector, which has the same column size and column indexes as the distributed semantic matrix and represents a distribution of all vocabulary words except the correct vocabulary word in the input sentence, may be used.

Referring to FIG. 4, the computer may calculate similarities between the input sentence and the respective second words (S133). Here, the similarities of the respective second words to the input sentence may be calculated based on an inner product or a dot product between the S-row vectors generated for all words except the correct word in the input sentence and respective row vectors of the distributed semantic matrix corresponding to the plurality of second words. However, the method for calculating the similarities of respective second words to the input sentence may not be restricted to the above exemplary method, and any kind of methods for calculating the similarities of the respective second words to the input sentence may be used for exemplary embodiments according to the present disclosure.

Also, the computer may calculate similarities of the respective second words to the correct word (S134). Here, the similarities of the respective second words to the input sentence may be calculated based on an inner product or a dot product between the row vector of the distributed semantic matrix corresponding to the correct word and respective row vectors of the distributed semantic matrix corresponding to the plurality of second words. However, the method for calculating the similarities of respective second words to the correct word may not be restricted to the above exemplary method, and any kind of methods for calculating the similarities of the respective second words to the correct word may be used for exemplary embodiments according to the present disclosure.

Re-referring to FIG. 4, the computer may calculate third similarities by using second weighting values based on the similarities of the respective second words to the input sentence and the similarities of the respective second words to the correct word (S135). Here, the third similarities may be represented as a below equation 5.

$$Third Similarities = {Argmax}_{{i}_{1} \to {i}_{N}} ( α \frac{{W}_{i}^{T} \vec{s}}{\vert {W}_{i}^{T} \vert \vert \vec{s} \vert} + ( 1 - α ) \frac{{W}_{i}^{T} \vec{{w}_{t}}}{\vert {W}_{i}^{T} \vert \vert {W}_{t} \vert} ) \qquad [ Equation 5 ]$$

In the equation 5, Wᵢ^{T} may mean a corresponding row vector in the distributed semantic matrix for the plurality of second words, means a s row vector for words except the correct word in the input sentence, We may mean a row vector corresponding to the correct word in the distributed semantic matrix, and a may mean second weighting values. Here, fixed values or values inputted through the provided user interface may be used for the second weighting values. The first term

$$\frac{{W}_{i}^{T} \vec{s}}{\vert {W}_{i}^{T} \vert \vert \vec{s} \vert}$$

of the equation 5 may mean an inner product or a dot product of Wᵢ^{T} and \vec{s}, and the second term

$$\frac{{W}_{i}^{T} \vec{{w}_{t}}}{\vert {W}_{i}^{T} \vert \vert {W}_{t} \vert}$$

may mean an inner product or a dot product of Wᵢ^{T} and Wₜ.

In exemplary embodiments, the method for calculating the third similarities of the respective second words may not be restricted to the above exemplary method based on the equation 5. That is, any methods for calculating the third similarities of the respective second words based on similarities of the respective second words to the input sentence and similarities of the respective second words to the correct word may be used as well as the method based on the equation 5.

Re-referring to FIG. 4, the computer may compare the third similarities of the respective second words with a preset criterion, and select a plurality of words satisfying the preset criterion among the plurality of second words (S136). Here, a fixed value or a value inputted through the user interface may be used as the preset criterion which is compared to the third similarities of the respective second words. The computer may select a plurality of words having similarities higher than the preset criterion or having similarities lower than the preset criterion from the plurality of second words.

Re-referring to FIG. 4, the computer may determine whether the plurality of second words satisfy the preset criterion (S137). If the preset criterion is not satisfied, the second weighting values are adjusted (S138), and the steps S135 to S137 are repeated. For example, if the preset criterion is the number of words selected from the plurality of second words and the preset criterion is satisfied in the step S137, a step S138 is performed.

Re-referring to FIG. 4, the computer may acquire the words selected from the plurality of second words as one or more viewing words (S138). Here, the computer may generate a blank filling questing by using the one or more viewing words, the correct word, and the input sentence from which the correct word is removed.

According to an exemplary embodiment of the present disclosure, the third similarities of the respective second words may be calculated by using similarities of the respective second words to the input sentence and similarities of the respective second words to the correct word, and one or more viewing words may be generated based on the third similarities of the respective second words so that the blank filling question can be efficiently generated.

Also, if a corpus and a corpus count program corresponding to a language of the input sentence, the blank filling questions can by generated without being restricted to a specific language.

While the example embodiments of the present invention and their advantages have been described in detail, it should be understood that various changes, substitutions and alterations may be made herein without departing from the scope of the invention.

1. A method for automatically generating a blank filling question, performed in a digital information processing apparatus, the method comprising:
selecting a correct word according to preset criteria from an input sentence;
acquiring a plurality of first words from a vocabulary database such that a relationship between the selected correct word and each of the plurality of first words satisfies a preset first criterion;
acquiring a plurality of second words from the plurality of first words such that a relationship between the input sentence and each of the plurality of second words satisfies a preset second criterion; and
acquiring one or more viewing words satisfying a preset third criterion from the plurality of second words by using a relationship between each of the plurality of second words and the input sentence and a relationship between each of the plurality of second words and the correct word.

2. The method according to claim 1, wherein the acquiring a plurality of first words comprises:
calculating at least one similarity for each word of the vocabulary database by comparing the correct word and each word of the vocabulary database;
calculating first similarities for each word of the vocabulary database by using one or more of the at least one similarity; and
acquiring a plurality of words whose first similarities satisfy a preset criterion from the vocabulary database as the plurality of first words.

3. The method according to claim 2, wherein, in the calculating at least one similarity, each word in the vocabulary database is compared with the correct word, and semantic similarity, phonetic similarity, and spelling similarity for the each word is calculated.

4. The method according to claim 1, wherein the acquiring a plurality of second words from the plurality of first words comprises:
calculating a similarity of each word of the plurality of first words to the input sentence as a second similarity of each word of the plurality of first words by comparing each of the plurality of first words with the input sentence; and
comparing the second similarity of each of the plurality of first words with a predetermined threshold, and acquiring a plurality of words whose second similarities satisfy a predetermined threshold as the plurality of second words from the plurality of first vocabulary words.

5. The method according to claim 4, wherein the second similarity is calculated by applying first weighting values for adjusting selection of the plurality of second words to the similarity between the input sentence and each of the plurality of first words.

5. The method according to claim 1, wherein the acquiring one or more viewing words comprises:
generating a distributed semantic matrix satisfying a first predetermined criterion based on at least one vocabulary database and at least one text database;
generating a S row vector which has a same column size and same column indexes as the distributed semantic matrix and satisfies a second predetermined criterion for words except the correct word in the input sentence;
calculating input sentence similarities of the respective plurality of second words by using the S row vector;
calculating correct word similarities of the respective plurality of second words by using the distributed semantic matrix;
calculating third similarities of the respective plurality of second words based on the input sentence similarities of the respective plurality of second words and the correct word similarities of the respective plurality of second words; and
acquiring, as the one or more view words, words whose third similarities satisfy a third predetermined criterion from the plurality of second words.

7. The method according to claim 6, wherein, in the calculating input sentence similarities of the respective plurality of second words, row vectors of the distributed semantic matrix corresponding to the respective plurality of second words and the S row vector are used to calculate the input sentence similarities of the respective plurality of second words.

8. The method according to claim 6, wherein, in the calculating correct word similarities of the respective plurality of second words, row vectors of the distributed semantic matrix corresponding to the respective plurality of second words and a row vector of the distributed semantic matrix corresponding to the correct word are used to calculate the correct word similarities of the respective plurality of second words.

9. The method according to claim 6, wherein, in the calculating third similarities of the respective plurality of second words, the third similarities are calculated by respectively applying second weighting values for adjusting influences that each of the input sentence similarities and the correct word similarities cause on the third similarities to the input sentence similarities and the correct word similarities.

10. A computer-readable recording medium on which a program, which can be read by a digital processing apparatus and in which a method for automatically generating a blank filling question is implemented, is recorded,
wherein the program executes:
a step of selecting a correct word according to preset criteria from an input sentence;
a step of acquiring a plurality of first words from a vocabulary database such that a relationship between the selected correct word and each of the plurality of first words satisfies a preset first criterion;
a step of acquiring a plurality of second words from the plurality of first words such that a relationship between the input sentence and each of the plurality of second words satisfies a preset second criterion; and
a step of acquiring one or more viewing words satisfying a preset third criterion from the plurality of second words by using a relationship between each of the plurality of second words and the input sentence and a relationship between each of the plurality of second words and the correct word.
